(19) United States
(12) Patent Application Publication
(10) Pub. No.: US 2005/0243578 A1
(43) Pub. Date: Nov. 3, 2005

(54) Back light assembly and liquid crystal display apparatus having the same

(76) Inventors: Sang-Duk Lee, Gyeonggi-do (KR); Kyu-Seok Kim, Gyeonggi-do (KR); Jae-Ho Jung, Gyeonggi-do (KR)

Correspondence Address: MCGUIREWOODS, LLP, 1750 TYSONS BLVD, SUITE 1800, MCLEAN, VA, 22102, US

(21) Appl. No.: 10/518,460

(22) PCT Filed: Jul. 29, 2003
(86) PCT No.: PCT/KR03/01510

§ 371 Date: Dec. 22, 2004

(30) Foreign Application Priority Data
Aug. 3, 2002 (KR) 10-2002-0045957

(51) Int. Cl. F21V 7/04

(52) U.S. Cl. 362/617

(57) ABSTRACT

The backlight assembly includes a light source and a light guide plate. The light source includes a plurality of light generating parts that generate a first light. The light guide plate includes side surfaces, a light exiting surface and a light reflecting surface. The light exiting surface has a plurality of luminance-compensating patterns. The light reflecting surface faces the light exiting surface. The first light enters into the light guide plate via the light incident surface to form a second light. The second light is reflected on the light reflecting surface toward the light exiting surface to form a third light. The third light exits from the light guide plate via the light exiting surface. The luminance-compensating patterns uniformize a luminance of the third light. A thickness of the light guide plate decreases in a direction from the light incident surface to a center of the light guide plate.

### TECHNICAL FIELD

The present invention relates to back light assembly and a liquid crystal display (LCD) apparatus having the back light assembly, more particularly to the back light assembly having a reduced size and an enhanced light utilization efficiency, and a liquid crystal display apparatus having the back light assembly.

### BACKGROUND ART

Nowadays, an information-processing device has various shapes, various functions and high processing speed. An information-processing device needs a display device, such as liquid crystal display device, so as to display the processed information.

An electric field is applied to the liquid crystal molecule of the liquid crystal display device, and optical characteristics of the liquid crystal, such as a double refraction, a dichromatic property and a light scattering property are changed. Therefore, the liquid crystal display device displays an image.

The liquid crystal itself does not emit light. Therefore, the liquid crystal display device needs a light source so as to display an image.

A back light assembly is disposed under a liquid crystal display panel so as to provide the liquid crystal display panel with light. The back light assembly includes a lamp (or lamps) for generating light and a light guide plate for guiding the light generated from the lamp.

The lamp consumes most of electric power for operating the liquid crystal display device. Thus, an efficiency of guiding the light generated from the lamp toward the liquid crystal display panel is important so as to reduce power consumption. When the light guide plate does not guide the light efficiently, the luminance of the liquid crystal display panel is lowered and the lamp requires more electrical power so as to get enough luminance for an image display. Therefore, electrical power consumption of the liquid crystal display device increases.

Further, as the liquid crystal display device becomes larger, the amount of light for displaying an image increases. Therefore, the back light assembly needs more lamps, so that electrical power consumption of the lamps increases.

When the light utilization efficiency of the back light assembly is increased, the power consumption of the liquid crystal display device is reduced.

### DISCLOSURE OF THE INVENTION

The present invention provides a back light assembly having enhanced light utilization efficiency.

The present invention also provides a liquid crystal display apparatus having a lightweight, a thin thickness, a small size and enhanced light utilization efficiency. The back light assembly includes a light source and a light guide plate. The light source includes a plurality of light generating parts that generate a first light. The light guide plate includes side surfaces, a light exiting surface and a light reflecting surface. The side surfaces have a plurality of light incident surfaces. The light exiting surface has a plurality of luminance-compensating patterns. The light reflecting surface faces the light exiting surface. The first light enters into the light guide plate via the light incident surface to form a second light. The second light is reflected on the light reflecting surface toward the light exiting surface to form a third light. The third light exits from the light guide plate via the light exiting surface. The luminance-compensating patterns uniformize a luminance of the third light. A thickness of the light guide plate decreases in a direction from the light incident surface to a center of the light guide plate.

The liquid crystal display apparatus includes a backlight assembly, a receiving container, a liquid crystal display panel and a top chassis. The back light assembly includes a light source and a light guide plate. The light source includes a plurality of light generating parts that generate a first light. The light guide plate includes side surfaces, a light exiting surface and a light reflecting surface. The side surfaces have a plurality of light incident surfaces. The light exiting surface has a plurality of luminance-compensating patterns. The light reflecting surface faces the light exiting surface. The first light enters into the light guide plate via the light incident surface to form a second light. The second light is reflected on the light reflecting surface toward the light exiting surface to form a third light. The third light exits from the light guide plate via the light exiting surface. The luminance-compensating patterns uniformize a luminance of the third light. A thickness of the light guide plate decreases in a direction from the light incident surface to a center of the light guide plate.

The receiving container receives the backlight assembly. The liquid crystal display panel receives the light that exits from the light exiting surface and modulates a transmissivity of the light to display an image. The top chassis combines with the receiving container to fix the liquid crystal display panel to the receiving container.

The backlight assembly according to exemplary embodiments of the present invention guides the light effectively to enhance light utilization efficiency. Therefore, a power consumption of the liquid crystal display device is reduced.

The light reflecting surface of the light guide plate of the back light assembly is concave, so that a size and a weight of the light guide plate are reduced. Therefore a size and a weight of the liquid crystal display device are reduced.

The bottom surface of a receiving container of the liquid crystal display device is concave to form a space for receiving components of the liquid crystal display device. Therefore, a size of the liquid crystal display device is further reduced.

### BRIEF DESCRIPTION OF THE DRAWINGS

The above and other advantages of the present invention will be readily apparent by reference to the following detailed description when considered in conjunction with the accompanying drawings wherein:

FIG. 1 is an exploded perspective view showing a backlight assembly according to a first exemplary embodiment of the present invention;

FIG. 2 is a cross-sectional view taken along the line A-A′ of FIG. 1;

FIG. 3 is a plan view of a light guide plate having a luminance-compensating pattern of FIG. 2;

FIG. 4 is a plan view of a light guide plate having another luminance-compensating pattern;

FIG. 5 is an exploded perspective view showing a backlight assembly having a light reflecting plate;

FIG. 6 is an exploded perspective view showing a backlight assembly having another light reflecting plate;

FIG. 7 is a cross-sectional view taken along the line B-B′ of FIG. 6;

FIG. 8 is an exploded perspective view showing a backlight assembly according to a second exemplary embodiment of the present invention;

FIG. 9 is an exploded perspective view showing a backlight assembly according to a third exemplary embodiment of the present invention;

. FIG. 10 is an exploded perspective view showing a backlight assembly according to a fourth exemplary embodiment of the present invention;

FIG. 11 is an exploded perspective view showing an example of a liquid crystal display device according to the present invention;

FIG. 12 is a cross-sectional view taken along the line C-C′ of FIG. 11; and

FIG. 13 is a cross-sectional view showing another example of a liquid crystal display device according to the present invention.

### BEST MODE FOR CARRYING OUT THE INVENTION

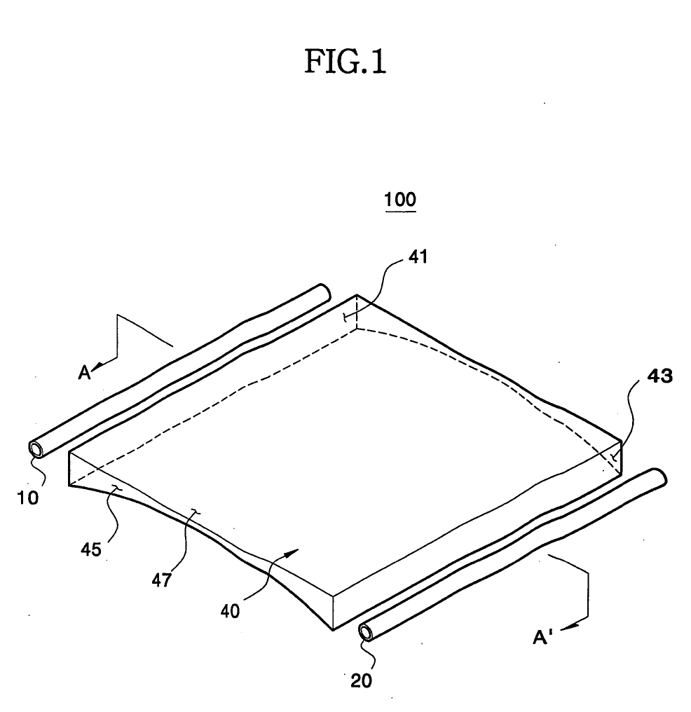

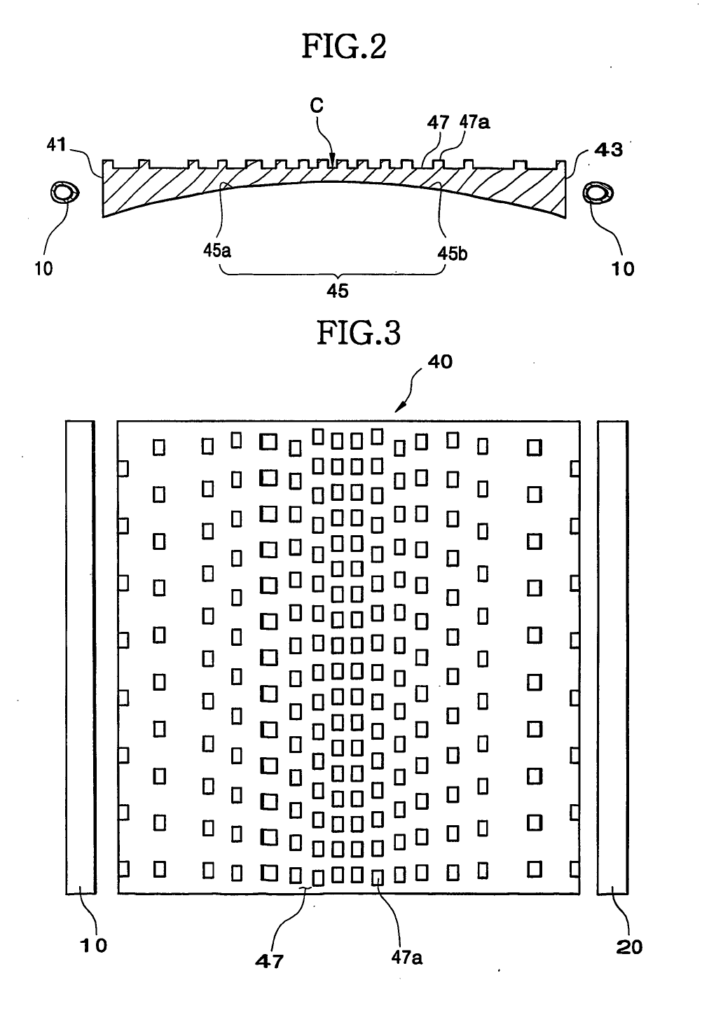

FIG. 1 is an exploded perspective view showing a backlight assembly according to a first exemplary embodiment of the present invention and FIG. 2 is a cross-sectional view taken along the line A-A′ of FIG. 1.

Referring to FIGS. 1 and 2, a backlight assembly 100 includes light sources 10 and 20, and a light guide plate 40 for guiding the light generated from the light sources 10 and 20.

The light sources 10 and 20 include first and second linear lamps 10 and 20. The light sources 10 and 20 apply light to the light guide plate 40.

The light guide plate 40 has a plate shape. The light guide plate 40 includes four side surfaces, a light reflecting surface 45 and a light exiting surface 47. The first straight type lamp 10 is disposed adjacent to a first side surface 41. The second linear lamp 20 is disposed adjacent to a second side surface 43.

The light guide plate 40 receives light through the first side surface 41 and the second side surface 43. The first and second side surfaces 41 and 43 face each other. The light reflecting surface 45 of the light guide plate 40 reflects the light applied through the first side surface 41 and the second side surface toward the light exiting surface 47.

The light incident from the first side surface 41 and the second side surface 43 may exit directly from the light guide plate 40 via the light exiting surface 47. The light incident from the first side surface 41 and the second side surface 43 may be reflected on the light reflecting surface 45 and exit from the light guide plate 40 via the light exiting surface 47.

As shown in FIGS. 1 and 2, the farther a distance is from the first side surface 41 and the second side surface 42, the thinner is the thickness of the light guide plate 40. The light reflecting surface 45 has a first light reflecting surface 45a and a second light reflecting surface 45b. The first light reflecting surface 45a corresponds to a first curved face having a first curvature. The first curve face extends from the first side surface 41 to a centerline C of the light guide plate 40.

The second light reflecting surface 45b corresponds to a second curved face having a second curvature. The second curved face extends from the second side surface 43 to the centerline C of the light guide plate 40.

Therefore, the light reflecting surface 45 has an arch-shape.

The first light reflecting surface 45a prevents a first light incident from the first side surface 41 from advancing to the second side surface 43 so that the first light may not be leaked.

The second light reflecting surface 45b prevents a second light incident from the second side surface 43 from advancing to the first side surface 41 so that the second light may not be leaked. Therefore, an amount of the light advancing to the light exiting surface 47 increases and the light utilization efficiency is enhanced.

Since each of the first light reflecting surface 45a and the second light reflecting surface 45b has a predetermined curvature, an angle formed by the light exiting from the light exiting surface 47 with respect to the light exiting surface 47 may be greater.

For example, the, first curvature and the second curvature may be the same with each other, when the brightness of the first light emitted from the first straight type lamp 10 is substantially equal to the brightness of the second light emitted from the second straight type lamp 20. However, the first curvature and the second curvature may have different value in accordance with the brightness the light emitted from the first linear lamp 10 and the second linear lamp 20.

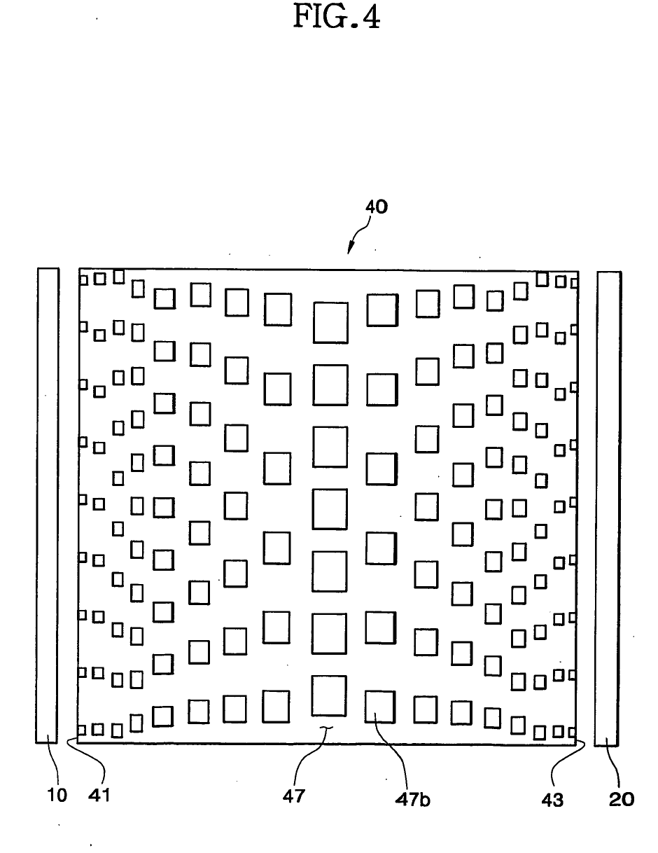

FIG. 3 is a plan view of a light guide plate having a luminance-compensating pattern of FIG. 2.

As shown in FIGS. 2 and 3, a luminance-compensating pattern 47a is formed on the light exiting surface 47 so that the light that exits from the light exiting surface 47 has uniform distribution of a luminance.

The nearer a region of the light guide plate 40 is to the first straight type lamp 10 and the second straight type lamp 20, the higher is the luminance of the light measured at the region of the light guide plate 40.

Thus, the luminance-compensating pattern 47a is formed to be sparser, in a direction from a center of the light guide plate 40 to the lamp 10 so as to compensate for the variation of the luminance.

The luminance-compensating pattern 47a may have a dot pattern distributed throughout the entire light exiting surface 47. The dot pattern of the luminance-compensating pattern 47a may have rectangular, triangular, circular or other polygonal pillar shape.

The height of the luminance-compensating dot pattern 47a may be equal to about 200 μm or less. The width of the luminance-compensating dot pattern 47a may be equal to about 200 μm or less.

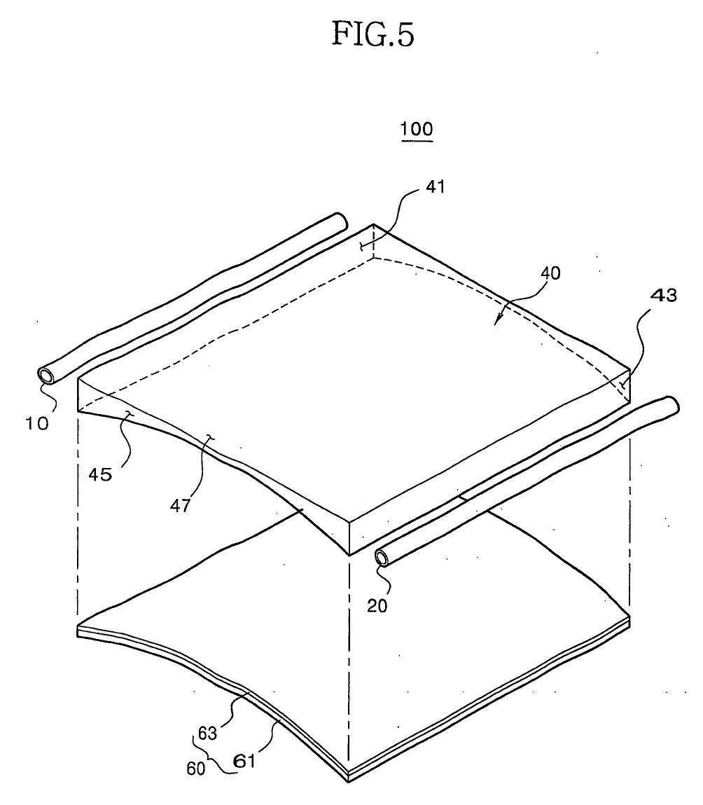

FIG. 4 is a plan view of a light guide plate having another luminance-compensating pattern.

Referring to FIG. 4, a luminance-compensating dot pattern 47b has different size in accordance with the distance from the first and second straight type lamps 10 and 20.

Hereinafter, the size of the luminance-compensating dot pattern is referred to as a volume of the luminance-compensating dot pattern. The luminance-compensating dot patterns 47b are formed to be smaller in a direction from a center of the light guide plate 40 to the first and second lamps 10 and 20.

As aforementioned, the size and the density of the luminance-compensating dot pattern are different in accordance with the region where the luminance-compensating dot pattern is formed, so that the luminance of the light exiting from the light exiting surface 47 may be adjusted and the light exiting from the light exiting surface 47 may have a uniform luminance.

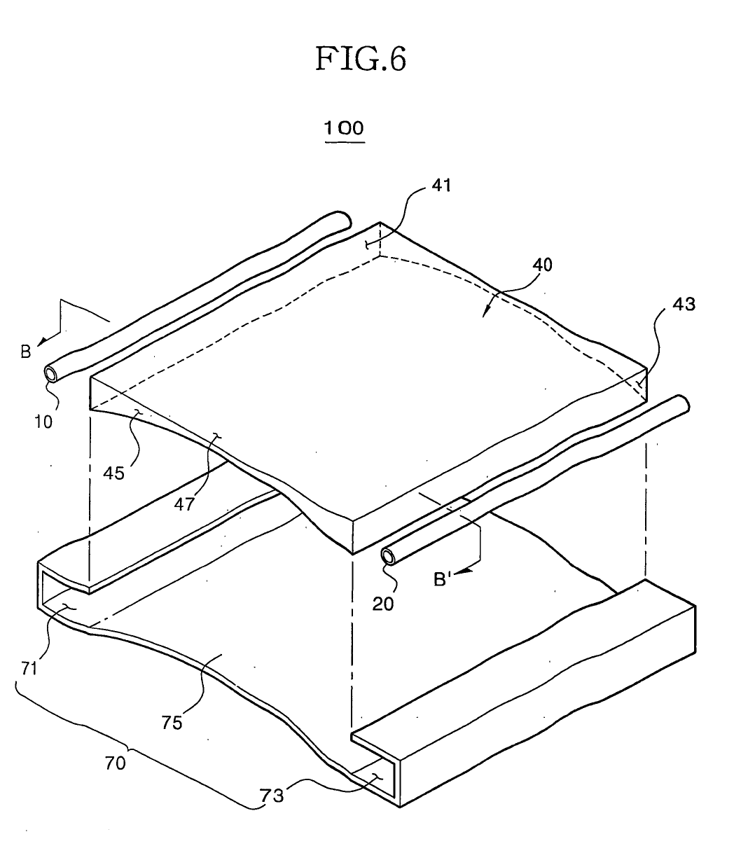

FIG. 5 is an exploded perspective view showing a backlight assembly having a light reflecting plate.

Referring to FIG. 5, a backlight assembly 100 further includes a light reflecting plate 60 disposed under the light guide plate 40 so as to reflect the light leaked from the light guide plate 40 toward the light guide plate 40.

The light reflecting plate 60 is attached on the light reflecting surface 45 of the light guide plate 40 to reflect the light leaked from the light reflecting surface 45 toward the light exiting surface 47.

For example, the surface of the light reflecting plate 60 has the same curvature as that of the light reflecting surface 45 of the light guide plate 40 so as to be closely adhered to the light reflecting surface 45.

When the curvature the surface of the light reflecting plate 60 is different from the curvature of the light reflecting surface 45 of the light guide plate 40, for example, the light reflecting plate 60 has a flat surface, there exists an air layer interposed between the light reflecting plate 60 and the light reflecting surface 45 of the light guide plate 40. The air layer reduces the light utilization efficiency of the back light assembly 100. Therefore, preferably, the curvature of the light reflecting plate 60 is substantially equal to the curvature of the light reflecting surface 45 of the light guide plate 40.

The light reflecting plate 60 includes a metal plate 61 having the same curvature as that of the light reflecting surface 45. A reflecting material 63 having superior reflectivity is coated on the metal pate 61.

The metal plate 61 has the same curvature as that of the light reflecting surface 45. The metal plate 61 comprises aluminum (Al), steel use stainless (SUS) or alloy of the aluminum and the steel use stainless (SUS). The reflecting material 63 comprises E60L having superior reflectivity.

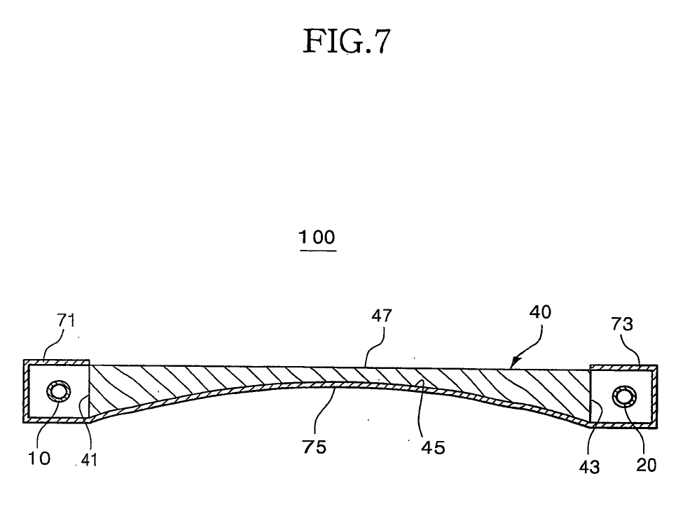

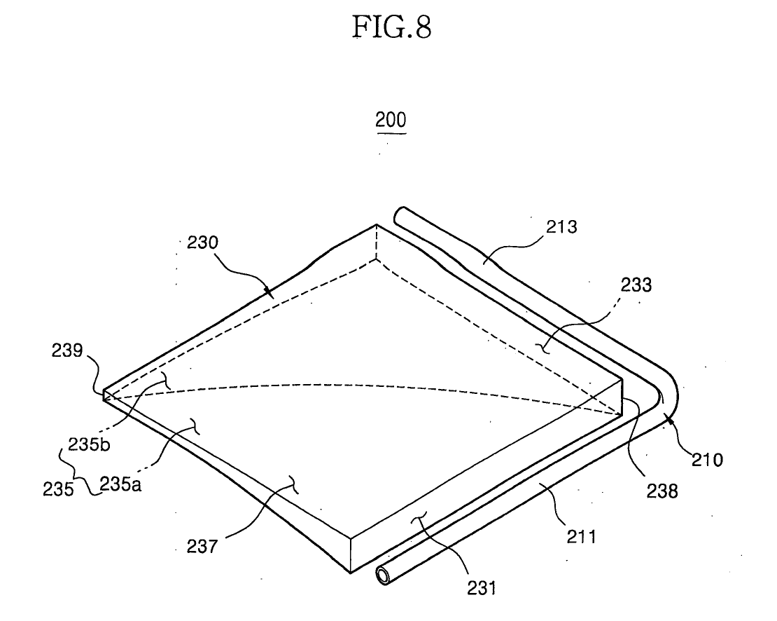

FIG. 6 is an exploded perspective view showing a backlight assembly having another light reflecting plate and FIG. 7 is a cross-sectional view taken along the line BB′ of FIG. 6.

Referring to FIGS. 6 and 7, a backlight assembly 100 includes a light guide plate 40, a first straight type lamp 10, a second straight type lamp 20 and a light reflecting plate 70. The first straight type lamp 10 is disposed adjacent to a first side surface 41 of the light guide plate 40. The second straight type lamp 20 is disposed adjacent a second side surface 43 of the light guide plate 40.

The light reflecting plate 70 includes a first lamp cover 71, a second lamp cover 73 and a reflecting plate 75. The first lamp cover 71 covers the first straight type lamp 10. The first lamp cover 71 reflects the first light generated from the first lamp 10, so that the light generated from the first lamp 10 advances to the first side surface 41 of the light guide plate 40.

The second lamp cover 73 covers the second straight type lamp 20. The second lamp cover 73 reflects the second light generated from the second lamp 20, so that the second light advances to the second side surface 43 of the light guide plate 40. The light reflecting plate 75 is disposed under the light guide plate 40 to reflect the light leaked from the light reflecting surface 45 toward the light exiting surface 47.

As shown in FIGS. 6 and 7, the first lamp cover 71, the second lamp cover 73 and the reflecting plate 75 are integrally formed. However, the first lamp cover 71 or the second lamp cover 73 may be separately formed and combined with the reflecting plate 75.

The reflecting plate 75 of the light reflecting plate 70 has the same curvature as that of the light reflecting surface 45 of the light guide plate 40. Although not shown in FIGS. 6 and 7, the first lamp cover 71, the second lamp cover 73 and the reflecting plate 75 comprise a metal plate coated by a reflecting substance.

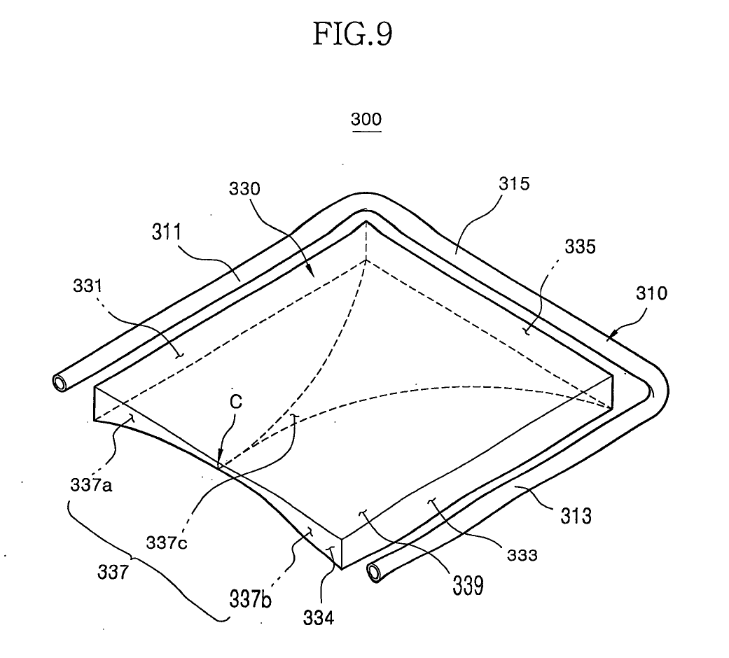

FIG. 8 is an exploded perspective view showing a backlight assembly according to a second exemplary embodiment of the present invention.

Referring to FIG. 8, the backlight assembly 200 according to second embodiment of the present invention includes an L-shaped lamp 210 and a light guide plate 230. The light guide plate 230 receives the light generated from the L-shaped lamp 210 and guides the light toward the light exiting surface 237. The L-shaped lamp 210 includes a first light generating part 211 and a second light generating part 213. The first light generating part 211 and the second light generating part 213 are integrally formed.

The light guide plate 230 has a plate shape. The light guide plate 230 includes four side surfaces, a light reflecting surface 235 and a light exiting surface 237. The first light generating part 211 faces a first side surface 231 and the second light generating part 213 faces a second side surface 233, so that the light guide plate 230 receives the light through the first side surface 231 and the second side surface 233.

The light applied to the light guide plate 230 through the first side surface 231 and the second side surface 233 exits from the light exiting surface 237. A first portion of light incident from the first side surface 231 and the second side surface 233 may exit directly from the light exiting surface 237. A second portion of light incident from the first side surface 231 and the second side surface 233 may be reflected on the light reflecting surface 235 and exit from the light exiting surface 237.

The farther a distance is from the first side surface 231 and the second side surface 233 is, the tier is the thickness of the light guide plate 230. The light reflecting surface 235 has a curved shape having a predetermined curvature, so that the light may exit from the light exiting surface 237 nearly perpendicularly to the light exiting surface 237. Further, the light reflecting surface 237 prevents the first light incident from the first side surface 231 from advancing to a third side surface opposite to the first side surface 231, so that the first light incident from the first side surface 231 may not be leaked from the third side surface opposite to the first side surface 231. The light reflecting surface 237 also prevents the second light incident from the second side surface 233 from advancing to a fourth side surface opposite to the second side surface 233, so that the second light incident from the second side surface 233 may not be leaked from the fourth side surface opposite to the second side surface 231. Therefore, an amount of the light advancing to the light exiting surface 47 increases and the light utilization efficiency is enhanced.

Hereinafter, the shape of the light reflecting surface 235 is disclosed in detail.

The first and second side surfaces 231 and 233 form a first edge 238. A second edge 239 is diagonally opposite to the first edge 238. As shown in FIG. 8, the father is from the first edge 238 and the closer is to the second edge 239, the thinner is the thickness of the light guide plate 230.

A large amount of light exits from the light guide plate 230 via a first region disposed adjacent to the first light generating part 211 and the second light generating part 213. A small amount of light exits from the light guide plate 230 via a second region adjacent to the second edge 239, because the region adjacent to the second edge 239 is far from the first light generating part 211 and the second light generating part 213.

The light reflecting surface 235 includes a first light reflecting surface 235a and a second light reflecting surface 235b. The farther a distance is from the first side surface 231 and the closer a distance is to the second edge 239, the thinner is the thickness of the first light reflecting surface 235a. The farther a distance is from the second side surface 233 and the closer to the second edge 239, the thinner is the thickness of the second light reflecting surface 235b.

FIG. 8 discloses the backlight assembly 200 including a light reflecting surface 235 having a finite curvature.

However, the light reflecting surface 235 may have a flat surface. When the light reflecting surface 235 has a flat surface, the farther a distance is from the first side surface 231 and the closer a distance is to the second edge 239, the thinner is the thickness of the first light reflecting surface 235a. When the light reflecting surface 235 has a flat surface, the farther a distance is from the second side surface 233 and the closer to the second edge 239, the thinner is the thickness of the second light reflecting surface 235b.

Although not shown in FIG. 8, a luminance-compensating pattern is formed on the light exiting surface 237 so that the light exiting from the light exiting surface 237-has uniform luminance.

The luminance-compensating patterns are formed to be denser in a direction from the L-shaped lamp 210 to an opposite side of the L-shaped lame 210. Therefore, the light exiting from all portions of the light exiting surface 237 of the light guide plate 230 has uniform luminance.

In FIG. 8, the backlight assembly 200 having the light guide plate 230 employs an L-shaped lamp 210. However, the back light assembly having the light guide plate 230 of FIG. 8 may employ two straight type lamps of FIG. 1 disposed adjacent the first side surface 231 and the second side surface 233 respectively.

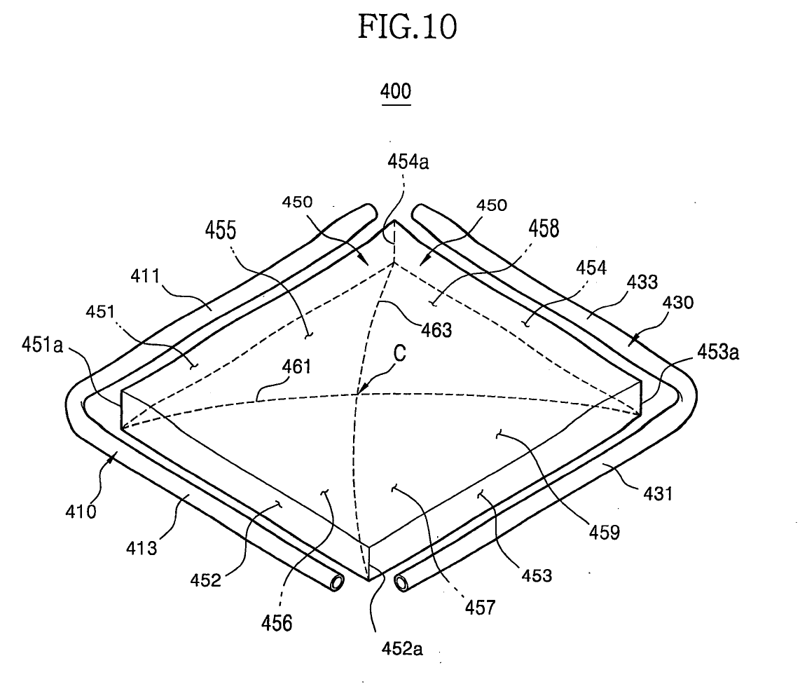

FIG. 9 is an exploded perspective view showing a backlight assembly according to a third exemplary embodiment of the present invention.

Referring to FIG. 9, the backlight assembly 300 according to third embodiment of the present invention includes an U-shaped lamp 310 and a light guide plate 330. The light guide plate 330 receives light generated from the U-shaped lamp 310 and guides the light toward the light exiting surface 339. The U-shaped lamp 310 includes a first light generating part 311, a second light generating part 313 and a third light generating part 315. The first light generating part 31 , the second light generating part 313 and the third light generating part 315 may be integrally formed.

The light guide plate 330 has a plate shape and includes four side surfaces, a light reflecting surface 337 and a light exiting surface 339. The first light generating part 311 faces a first side surface 331, the second light generating part 313 faces a second side surface 333 and the third light generating part 315 faces a third side surface 335, so that the light guide plate 330 receives the light through the first side surface 331, the second side surface 333 and the third side surface 335. The light applied to the light guide plate 330 through the first side surface 331, the second side surface 333 and the third side surface 335 exits from the light exiting surface 339. The light incident from the first side surface 331, the second side surface 333 and the third side surface 335 may exit directly from the light exiting surface 339. The light incident from the first side surface 331, the second side surface 333 and the third side surface 335 may be reflected on the light reflecting surface 337 and exit from the light exiting surface 339.

The farther a distance is from the first side surface 331, the second side surface 333 and the third side surface 335, the thinner is the thickness of the light guide plate 330.

Namely, the nearer is to the center C of the fourth side surface 334 facing the third side surface 335, the thinner is the thickness of the light guide plate 330.

The light reflecting surface 337 includes a first light reflecting surface 337a disposed near the first side surface 331, a second light reflecting surface 337b disposed near the second side surface 333 and a third light reflecting surface 337c disposed near the third side surface 335. Each of the first light reflecting surface 337a, the second light reflecting surface 337b and the third light reflecting surface 337c has a curved surface having a predetermined curvature.

The first light reflecting surface 337a prevents a first light incident from the first side surface 331 from advancing to the second side surface 333 so that the first light incident from the first side surface 331 may not be leaked. The second light reflecting surface 337b prevents a second light incident from the second side surface 333 from advancing to the first side surface 331 so that the second light incident from the second side surface 333 may not be leaked. The third light reflecting surface 337c prevents a second light incident from the third side surface 335 from advancing to the fourth side surface 334 so that the second light incident from the third side surface 335 may not be leaked. Therefore, an amount of the light advancing to the light exiting surface 339 increases and the light utilization efficiency is enhanced.

Although not shown in FIG. 9, a luminance-compensating pattern is formed on the light exiting surface 339 so that the light exiting from the light exiting surface 339 may have a uniform luminance. The luminance-compensating patterns are formed to be denser in a direction from the U-shaped lamp 310 to an opposite side of the U-shaped lame 310. Therefore, the light exiting from all portions of the light exiting surface 339 of the light guide plate 330 has uniform luminance.

In FIG. 9, a backlight assembly 300 having the light guide plate 330 employs an U-shaped lamp 310. However, a backlight assembly 300 having the light guide plate 330 of FIG. 9 may employs one L-shaped lamp 210 of FIG. 8 and one straight type lamp of FIG. 1 or three straight type lamps of FIG. 1 in order to form U-shaped lamp.

FIG. 10 is an exploded perspective view showing a backlight assembly according to a fourth exemplary embodiment of the present invention.

Referring to FIG. 10, the backlight assembly 400 according to fourth embodiment of the present invention includes a first L-shaped lamp 410, a second L-shaped lamp 430 and a light guide plate 450. The light guide plate 450 receives the light generated from the first L-shaped lamp 410 and the second L-shaped lamp 430, and guides the light toward the light exiting surface 459. The first L-shaped lamp 410 includes a first light generating part 411 and a second light generating part 413. The second L-shaped lamp 430 comprises a third light generating part 431 and a fourth light generating part 433. The first light generating part 411 and the second light generating part 413 may be integrally formed. The third light generating part 431 and the fourth light generating part 433 may be integrally formed.

The light guide plate 450 includes four side surfaces 451, 452, 453 and 454, a light reflecting surfaces 455, 456, 457 and 458, and a light exiting surface 459. Light is applied to the light guide plate 450 through the first side surface 451, the second side surface 452, the third side surface 453 and the fourth side surface 454. The first light generating part 411 is disposed near the first side surface 451. The second light generating part 413 is disposed near the second side surface 452 connected with the first side surface 451. The third light generating part 431 is disposed near the third side surface 453 facing the first side surface 451. The fourth light generating part 433 is disposed near the fourth side surface 454 facing the second side surface. The light reflecting surfaces 455, 456, 457 and 458 reflect the light incident from the side surfaces 451, 452, 453 and 454 toward the light exiting surface 459.

The light incident from the side surfaces 451, 452, 453 and 454 may exit directly from the light exiting surface 459, or the light incident from the side surfaces 451, 542, 453 and 454 may be reflected on the light reflecting surfaces 455, 456, 457 and 458 and exit from the light exiting surface 459.

The farther is a distance from the side surfaces 451, 542, 453 and 454, the thinner is the thickness of the light guide plate 330.

Namely, the nearer is a distance to the center C; the thinner is the thickness of the light guide plate 330. The center C is an intersecting point of a first diagonal line 461 and a second diagonal line 463. The first diagonal line 461 extended from a first edge 451a defined by the first side surface 451 and the second side surface 452 to a second edge 453a defined by the third side surface 453 and the fourth side surface 454. The second diagonal line 463 is extended from a third edge 454a defined by the first side surface 451 and the fourth side surface 454 to a fourth edge 452a defined by the third side surface 453 and the second side surface 452.

The light reflecting surfaces includes a first light reflecting surface 455 having a triangular curved shape defined by the first side surface 451 and the center C, a second light reflecting surface 456 having a triangular curved shape defined by the second side surface 452 and the center C, a third light reflecting surface 457 having a triangular curved shape defined by the third side surface 453 and the center C, and a fourth light reflecting surface 458 having a triangular curved shape defined by the fourth side surface 454 and the center C. Each of the first light reflecting surface 455, the second light reflecting surface 456, the third light reflecting surface 457 and the fourth light reflecting surface 459 has either the same or different curvature of each other.

Therefore, the light reflecting surfaces 455, 456, 457 and 458 prohibit the light incident from the side surfaces 451, 452,453 and 454 from leaking through the side surfaces 451, 452, 453 and 454 so that the light utilization efficiency is enhanced.

Although not shown in FIG. 10, a luminance-compensating pattern is formed on the light exiting surface 459 so that the light exiting from the light exiting surface 459 may have a uniform luminance. The luminance-compensating patterns are formed to be sparser in a direction from the center of the light guide plate 430 to an edge of the light guide plate 430. Therefore, the light exiting from all portions of the light exiting surface 459 of the light guide plate 430 has uniform luminance.

In FIG. 10, a backlight assembly 400 adopts two L-shaped lamps 410 and 430. However, a backlight assembly 400 may adopt four straight type lamps of FIG. 1 or one L-shaped lamp 210 of FIG. 8 and two straight type lamp of FIG. 1.

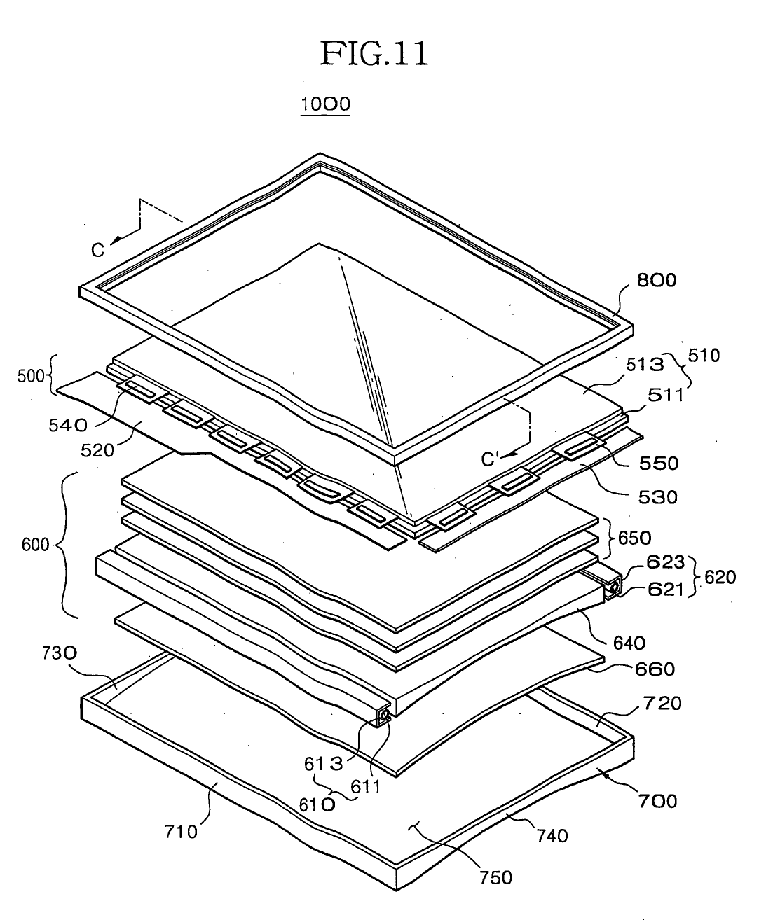

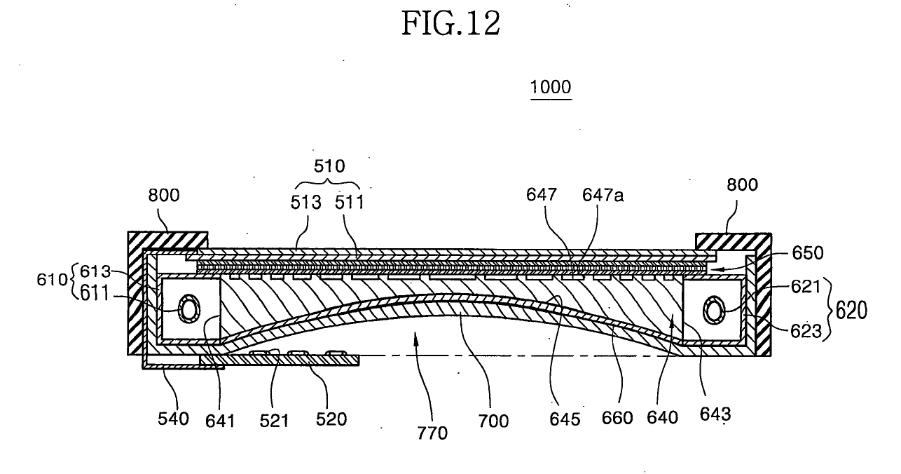

FIG. 11 is an exploded perspective view showing an example of a liquid crystal display device according to the present invention, and FIG. 12 is a cross-sectional view taken along the line CC′ of FIG. 11. For example, in FIGS. 11 and 12, two straight type lamps are attached to the light guide plate.

Referring to FIGS. 11 and 12, a liquid crystal display device 1000 includes a display unit 500 for displaying an image when image signal is applied to the display unit, a backlight assembly 600 for providing the display unit 500 with light, a receiving container 700 and top chassis 800 for receiving the display unit 500 and the backlight assembly 600.

The display unit 500 includes a liquid crystal display panel 510, a data printed circuit board 520, a gate printed circuit board 530, a data tape carrier package 540 and gate tape carrier package 550. The liquid crystal display panel 510 includes a thin film transistor substrate 511, a color filter substrate 513 and a liquid crystal layer (not shown).

The thin film transistor substrate 511 includes a transparent glass substrate on which thin film transistors are arranged in a matrix shape. A source electrode of the thin film transistor is electrically connected to a data line. A gate electrode of the tin film transistor is electrically connected to a gate line. A drain electrode of the thin film transistor is electrically connected to the pixel electrode. The pixel electrode comprises Indium Tin Oxide (ITO). The indium tin oxide is a conductive and transparent material. When electric signals are applied to the data line, the electric signal is transferred to the source electrode according as the thin film transistor is turned on or turned off, so that an electrical signal is applied to the pixel electrode through the drain electrode of the thin film transistor and an image is displayed.

The color filter substrate 513 includes RGB color filters. Light passes through the RGB color filters, so that desired colors are displayed. The RGB color filters are formed on the color filter substrate 513. The common electrode comprising indium tin oxide is formed on the color filter substrate 513.

When the electric signal is applied to the source electrode of the thin film transistor and the thin film transistor is turned on, electric fields are formed between the pixel electrode of the thin film transistor substrate 511 and the common electrode of the color filter substrate 513. The electric fields adjust an alignment angle of the liquid crystal molecule disposed between the thin film transistor substrate 211 and the color filter substrate 213. Then, the transmissivity of the liquid crystal is changed and an image is displayed.

As shown in FIG. 11, the data tape carrier package 540 is attached to one side of the liquid crystal display panel 510 and the gate tape carrier package 550 is attached to the other side of the liquid crystal display panel 510. The data tape carrier package 540 determines the point of time to apply an image signal. The gate tape carrier package 550 determines the point of time to apply the gate driving signal. The data printed circuit board 520 is electrically connected to the data tape carrier package 540, receives external image signal and provides the date line with the image signal. The gate printed circuit board 530 is electrically connected to the gate tape carrier package 550 and it provides the gate line with the gate driving signal.

In FIG. 11, the data printed circuit board 520 and the gate printed circuit board 530 are separately formed. However, the liquid crystal display device may include an integrated printed circuit board (not shown) having the functions of both the data printed circuit board 520 and the gate printed circuit board 530.

As shown in FIGS. 11 and 12, the backlight assembly 600 includes a first light generating part 610, a second light generating part 620 and a light guide plate 640 for guiding the light generated from the first and second light generating part 610 and 620 toward the exiting surface of the light guide plate 640. The first light generating part 610 includes a first straight type lamp 611 and a first lamp reflector 613 that covers the first straight type lamp 611 and reflects the light reflected on the first lamp reflector 613 toward the light guide plate 640. The second light generating part 620 includes a second straight type lamp 621 and a second lamp reflector 623 that covers the second straight type lamp 621 and reflects the light reflected on the second lamp reflector 623 toward the light guide plate 640.

The light guide plate 640 has a plate shape. The light guide plate 640 includes a light reflecting surface 645, light exiting surface 647 and four side surfaces. The light guide plate 640 receives light through a first side surface 641 and a second side surface 643. The first light generating part 610 is disposed adjacent the first side surface 641, and the second light generating part 620 is disposed adjacent the second side surface 643. The first side surface 641 and the second side surface 643 face each other. The light reflecting surface 645 reflects the light incident from the first side surface 641 and the second side surface 643 toward the light exiting surface 647. The light incident from the first side surface 641 and the second side surface 643 directly exit from the light exiting surface 647, or the light incident from the first side surface 641 and the second side surface 643 is reflected on the light reflecting surface 645 and then exits from the light exiting surface 647.

The farther a distance is from the first side surface 641 and the second side surface 643, the thinner is the thickness of the light guide plate 640. The light reflecting surface 645 has arch-shaped curved surface having a predetermined curvature.

Therefore, the light reflecting surface 645 prevents the light incident from the first side surface 641 from advancing toward the second side surface 643. Therefore, the light does not leak from the second side surface 643. The light reflecting surface 645 prevents the light incident from the second side surface 643 from advancing toward the first side surface 641. Therefore, the light does not leak from the first side surface 641. Therefore, most of the light generated from the first light generating part 610 and the second light generating part 620 advances toward to the light exiting surface 647, so that the light utilization efficiency is enhanced.

As shown in FIG. 12, a luminance-compensating pattern 647a is formed on the light exiting surface 647a so as to provide a uniform distribution of luminance of the light exiting from the light exiting surface 647a. The light reflected on the light reflecting surface 645 has non-uniform distribution of luminance. The luminance-compensating pattern 647a diffuses the light reflected on the light reflecting surface 645, so that the light exiting from the light exiting surface 647 has uniform distribution of luminance.

The luminance of light that exits from a region near the lamps 611 and 621 is higher than that of light that exits from a center of the light guide plate 640.

Thus, luminance-compensating patterns 647a are formed to be sparser in a direction from the center of the light guide plate 640 to the lamps 611 and 612, so as to compensate the luminance.

The reflection face 645 of the light guide plate 640 has the arch-shaped curved shape, so that the weight and volume of the light guide plate 640 are reduced, in comparison with the conventional flat type light guide plate, of which light reflecting surface is substantially parallel to an light exiting surface of the light guide plate and have a flat surface. Therefore, the weight and size of the liquid crystal display device 1000 are reduced.

The backlight assembly 600 further includes a reflecting plate 660 disposed under the light guide plate 640 so as to reflect the light leaked from the light reflecting surface 645 toward the light exiting surface 647. The reflecting plate 660 has the same curvature as that of the light reflecting surface 645 to be closely adhered to the light reflecting surface 645. Therefore, the light reflecting surface 645 reflects the light leaked from the light reflecting surface 645 effectively. The reflecting plate 660 includes a metal plate having the same curvature as that of the light reflecting surface 645, and reflecting substance is coated on the metal plate.

The backlight assembly 600 further includes an optical sheets 650 disposed over the light guide plate 640 so as to adjusting the distribution of luminance of the light exiting from the light exiting surface 647 and a viewing angle of the light exiting from the light exiting surface 647. The backlight assembly 600 may not include the optical sheets 650, because the luminance of the light exiting from the light exiting surface 647 may be compensated by the luminance-compensating pattern 647a.

The liquid crystal display device 1000 further includes a receiving container 700. The receiving container 700 receives the first light generating part 610, the second light generating part 620, the reflecting plate 660, the light guide plate 640 and the optical sheets in the named order. The receiving container 700 includes four sidewalls 710,720, 730 and 740, and bottom face 750.

The first light generating part 610 and the second light generating part 620 are received by the receiving container 700 and disposed adjacent to the sidewalls 710 and 720, respectively. The reflecting plate 660 is disposed on the bottom face 750 of the receiving container 700. The bottom face 750 has the same curvature as that of the reflecting plate 660 so as to support the reflecting plate 660. For example, the receiving container 700 includes metal having enough solidity to stably receive and support the backlight assembly 600.

The light guide plate 640 is disposed on the reflecting plate 660, such that the light reflecting surface 645 faces the reflecting plate 660. The optical sheets 650 are disposed on the light guide plate 640. When the receiving container 700 receives the backlight assembly 600, the display unit 500 is disposed on the backlight assembly 600.

The top chassis 800 is mounted on the receiving container 700, so that the display unit 500 is fixed. The top chassis 800 includes an upper face and sidewalls. When the top chassis 800 is mounted on the receiving container 700, the upper face of the top chassis 800 presses the ineffective display region of the liquid crystal display panel 510, and the sidewalls of the top chassis 800 face the sidewalls of the receiving container 700.

The bottom face 750 of the receiving container 700 has arch-shaped curved shape like the reflecting plate 660, so that a receiving space 770 is formed under the receiving container 700. The receiving space 700 receives electronic components 521 mounted on the data printed circuit board 520. Therefore, the thickness of the liquid crystal display device 1000 is reduced.

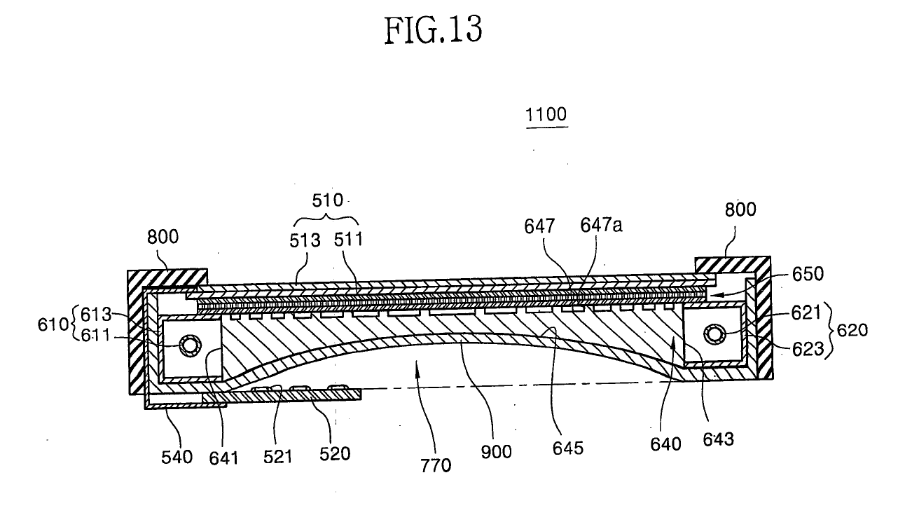

FIG. 13 is a cross-sectional view showing another example of a liquid crystal display device according to the present invention.

Referring to FIG. 13, the liquid crystal display device 1100 according to a sixth embodiment of the present invention includes a display unit 500 for display an image when an image signal is applied to the display unit 500, a backlight assembly 600 for providing the display unit 500 with light, a receiving container 900 for receiving the display unit 500 and the backlight assembly 600, and a top chassis 800.

The receiving container 900 includes four sidewalls and bottom face to receive the backlight assembly 600. The bottom face of the receiving container 900 has the same curvature as that of the light reflecting surface 645 of the light guide plate 640 so as to support the light guide plate 640. The receiving container 700 includes a metal plate and a reflecting substance coated on the metal plate. Therefore, the receiving container 700 reflects the light leaked from the light reflecting surface 645 of the light guide plate 640 toward the light exiting surface 647 of the light guide plate 640, so that the liquid crystal display device 1100 of FIG. 13 does not have the reflecting plate. Therefore, the thickness and the weight of the liquid crystal display device 1100 are reduced.

The bottom face of the receiving container 900 has arch-shaped curved surface, so that a receiving space 770 is formed under the receiving container 900. The receiving space 770 receives electronic components mounted on the printed circuit board 520. Therefore, the thickness of the liquid crystal display device 1100 is reduced.

### Industrial Applicability

The backlight assembly according to the embodiments of the present invention guides the light effectively to enhance light utilization efficiency. Therefore, a power consumption of the liquid crystal display device is reduced.

The light reflecting surface of the light guide plate of the backlight assembly is concave, so that a size and a weight of the light guide plate are reduced. Thus, a size and a weight of the liquid crystal display device are reduced.

The bottom face of a receiving container of the liquid crystal display device is concave to form a space for receiving components of the liquid crystal display device. Therefore, a size of the liquid crystal display device is further reduced.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

1. A backlight assembly comprising:
a light source including a plurality of light generating parts that generate a first light; and
a light guide plate including i) side surfaces having a plurality of light incident surfaces, ii) a light exiting surface having a plurality of luminance-compensating patterns, and iii) a light reflecting surface facing the light exiting surface, the first light entering into the light guide plate via the light incident surface to form a second light, the second light being reflected on the light reflecting surface toward the light exiting surface to form a third light, the third light exiting from the light guide plate via the light exiting surface, the luminance-compensating patterns uniformizing a luminance of the third light, and a thickness of the light guide plate decreasing in a direction from the light incident surface to a center of the light guide plate.

2. The backlight assembly of claim 1, wherein the light guide plate comprises first, second, third and fourth side surfaces, and the light source comprises first and second light generating parts disposed adjacent to the first side surface and the second side surface facing the first side surface, respectively.

3. The backlight assembly of claim 2, wherein the thickness of the light guide plate decreases gradually to form an arch-shaped light reflecting surface.

4. The backlight assembly of claim 2, wherein the light source further comprises a third light generating part disposed adjacent to the third side surface of the light guide plate, and the first, second and third light generating parts are integrally formed to form a U-shape.

5. The backlight assembly of claim 1, wherein the light guide plate comprises a first side surface, a second side surface neighboring the first side surface, a third side surface facing the first side surface, and a fourth side surface facing the second side surface, and the light source comprises a first light generating part disposed adjacent to the first side surface, a second light generating part disposed adjacent to the second side surface, a third light generating part disposed adjacent to the third side surface, and a fourth light generating part disposed adjacent to the fourth side surface.

6. The backlight assembly of claim 5, wherein the light reflecting surface has first, second, third and fourth curved faces, each of the curved faces having a predetermined curvature.

7. The backlight assembly of claim 5, wherein the first and second light generating parts are integrally formed to form a first L-shaped lamp, and the third and fourth light generating parts are integrally formed to form a second L-shaped lamp.

8. The backlight assembly of claim 1, further comprising a first reflecting member disposed under the light reflecting surface of the light guide plate, the first reflecting member reflecting a third light leaked from the light reflecting surface toward the light exiting surface, the first reflecting member comprising a metal plate and a reflective substance formed on the metal plate.

9. The backlight assembly of claim 8, further comprising a second reflecting member covering the light sources to reflect the first light generated from the light source toward the light guide plate, and the first and second reflecting members being integrally formed with each other.

10. The backlight assembly of claim 1, wherein each of the luminance-compensating patterns has a same size, and the light-compensating patterns are formed denser in a region disposed near a center of the light guide plate than in a region disposed near the light generating part.

11. The backlight assembly of claim 1, wherein the luminance-compensating patterns are formed denser and have larger size in a region disposed near a center of the light guide plate than in a region disposed near the light generating part.

12. A liquid crystal display apparatus comprising:
a backlight assembly including, a) a light source including a plurality of light generating parts that generate a first light, and b) a light guide plate including i) side surfaces having a plurality of light incident surfaces, ii) a light exiting surface having a plurality of luminance-compensating patterns, and iii) a light reflecting surface facing the light exiting surface, the first light entering into the light guide plate via the light incident surface to form a second light, the second light being reflected on the light reflecting surface toward the light exiting surface to form a third light, the third light exiting from the light guide plate via the light exiting surface, the luminance-compensating patterns uniformizing a luminance of the third light, a thickness of the light guide plate decreasing in a direction from the light incident surface to a center of the light guide plate;
a receiving container for receiving the backlight assembly;
a liquid crystal display panel, received in the receiving container, for controlling a transmissivity of the second light using a liquid crystal to display an image; and
a top chassis, combined with the receiving container, for fixing the liquid crystal display panel to the receiving container.

13. The liquid crystal display apparatus of claim 12, further comprising a reflecting member disposed on a lower surface of the light reflecting surface of the light guide plate, the reflecting member reflecting a third light leaked from the light reflecting surface toward the light exiting surface, the reflecting member having a same contour as that of the light reflecting surface of the light guide plate.

14. The liquid crystal display apparatus of claim 13, wherein a bottom face of the receiving container has a same contour as that of the light reflecting surface of the light guide plate, a electronic component being received in a receiving space under the bottom face of the receiving container.

15. The liquid crystal display apparatus of claim 12, wherein the receiving container has a same contour as that of the light reflecting surface of the light guide plate and comprises a metal plate and a reflective substance formed on the metal plate, and the receiving container reflecting a third light leaked from the light reflecting surface toward the light exiting surface.
